(19) United States
(12) Patent Application Publication
(10) Pub. No.: US 2022/0224595 A1
(43) Pub. Date: Jul. 14, 2022

(54) OPTICAL COMMUNICATION DEVICE AND CONTROL METHOD

(71) Applicant: Mitsubishi Electric Corporation, Tokyo (JP)

(72) Inventors: Makiko ISHIDA, Tokyo (JP); Hideki SUEOKA, Tokyo (JP)

(73) Assignee: Mitsubishi Electric Corporation, Tokyo (JP)

(21) Appl. No.: 17/610,701

(22) PCT Filed: May 23, 2019
(86) PCT No.: PCT/JP2019/020420

§ 371 Date: Nov. 12, 2021

(51) Int. Cl. H04L 41/0668; H04B 10/03; H04B 10/079; H04L 12/44; H04L 41/0695

(52) U.S. Cl. CPC H04L 41/0668; H04B 10/03; H04Q 11/0067; H04L 12/44; H04L 41/0695; H04B 10/0795

(57) ABSTRACT

An OLT includes a storage unit that stores management information indicating that a first address has been assigned to a client device that connects to an ONU as an operational system and an ONU as a standby system, a detection unit that detects occurrence of a failure to the ONU, a communication control unit that, connects to the ONU when the occurrence of the failure to the first slave station device is detected and controls communication performed by the client device so that the client device connects to the Internet via the ONU and the OLT, and a monitoring unit that monitors unauthorized use of the first address based on the management information both when the client device connects to the Internet via the ONU and the OLT and when the client device connects to the Internet via the ONU and the OLT.

### TECHNICAL FIELD

The present invention relates to an optical communication device, a control method and a control program.

### BACKGROUND ART

There has been known a communication system including a Passive Optical Network (PON) system that is an optical communication system. The PON system includes an optical communication device (referred to also as a “master station device”) installed in a station of a telecommunications carrier and a plurality of optical communication devices (referred to also as “slave station devices”) installed on the subscribers' side. The master station device is referred to as an Optical Line Termination (OLT). The slave station device is referred to as an Optical Network Unit (ONU).

In communication systems, IP over Ethernet (IPoE) (registered trademark) is used as a technology for connecting to a host network such as the Internet. Further, a communication system includes a Dynamic Host Configuration Protocol (DHCP) server. The DHCP server assigns an Internet Protocol (IP) address to a client device connected to the ONU. The client device is capable of connecting to the host network by using the IP address.

Furthermore, in communication systems, there are cases where a configuration in the system has become redundant in order to increase the reliability of the system. For example, there has been proposed a technology regarding a redundant configuration (see Patent Reference 1 and Non-patent Reference 1).

### PRIOR ART REFERENCE

### Patent Reference

Patent Reference 1: Japanese Patent Application Publication No. 2017-175176

### Non-Patent Reference

Non-patent Reference 1: ITU-T Recommendation G.983.1

### SUMMARY OF THE INVENTION

### Problem to be Solved by the Invention

Incidentally, the OLT has stored information regarding the client device connected to each ONU. The OLT monitors unauthorized use of the IP address assigned to the client device by using the information.

Further, when an ONU has a redundant configuration, the OLT stores information regarding the client device connected to the ONU as an operational system. Incidentally, in the convention, when an ONU as a standby system is switched to the operational system, the OLT deletes the information regarding the client device connected to the operational-system ONU. Then, the OLT generates information regarding the client device connected to the standby-system ONU. In this case, the communication system does not connect the client device to the host network until the information is generated. That is because the OLT cannot carry out the monitoring by using the information.

As above, the client device cannot connect to the host network until the information is generated. Thus, there is a problem in that the client device cannot connect to the host network for a long time.

An object of the present invention is to let the client device connect to a network in a short time.

### Means for Solving the Problem

A communication system includes a first slave station device as a slave station device as an operational system, a second slave station device as a slave station device as a standby system, a master station device that connects to a network, and a client device that connects to the first slave station device and the second slave station device and connects to the network via the first slave station device and the master station device by using a first address. There is provided an optical communication device according to an aspect of the present invention as the master station device in the communication system. The optical communication device includes a storage unit that stores management information indicating that the first address has been assigned to the client device that connects to the first slave station device and the second slave station device, a detection unit that detects occurrence of a failure to the first slave station device, a communication control unit that connects to the second slave station device when the occurrence of the failure to the first slave station device is detected and controls communication performed by the client device so that the client device connects to the network via the second slave station device and the master station device, and a monitoring unit that monitors unauthorized use of the first address based on the management information both when the client device connects to the network via the first slave station device and the master station device and when the client device connects to the network via the second slave station device and the master station device.

### Effect of the Invention

According to the present invention, it is possible to let the client device connect to the network in a short time.

### BRIEF DESCRIPTION OF THE DRAWINGS

FIG. 1 is a diagram showing a communication system in a first embodiment.

FIG. 2 is a sequence diagram showing an IP address assigning process in the first embodiment.

FIG. 3 is a diagram showing a configuration of hardware included in an OLT in the first embodiment.

FIG. 4 is a functional block diagram showing a configuration of the OLT in the first embodiment.

FIG. 5 is a diagram showing a concrete example of a management table in the first embodiment.

FIG. 6 is a functional block diagram showing a configuration of ONUs in the first embodiment.

FIG. 7 is a sequence diagram showing an example of a process executed in the communication system in the first embodiment.

FIG. 8 is a functional block diagram showing a configuration of ONUs in a second embodiment.

FIG. 9 is a functional block diagram showing a configuration of ONUs in a third embodiment.

FIG. 10 is a diagram showing an example of an ONU authentication table in the third embodiment.

FIG. 11 is a flowchart showing a process regarding ONU authentication and UNI blockage when an ONU redundant configuration is not employed in the third embodiment.

FIG. 12 is a flowchart showing a process regarding the ONU authentication and the UNI blockage when a new ONU has been added when the ONU redundant configuration is employed in the third embodiment.

### MODE FOR CARRYING OUT THE INVENTION

Embodiments will be described below with reference to the drawings. The following embodiments are just examples and a variety of modifications are possible within the scope of the present invention.

### First Embodiment

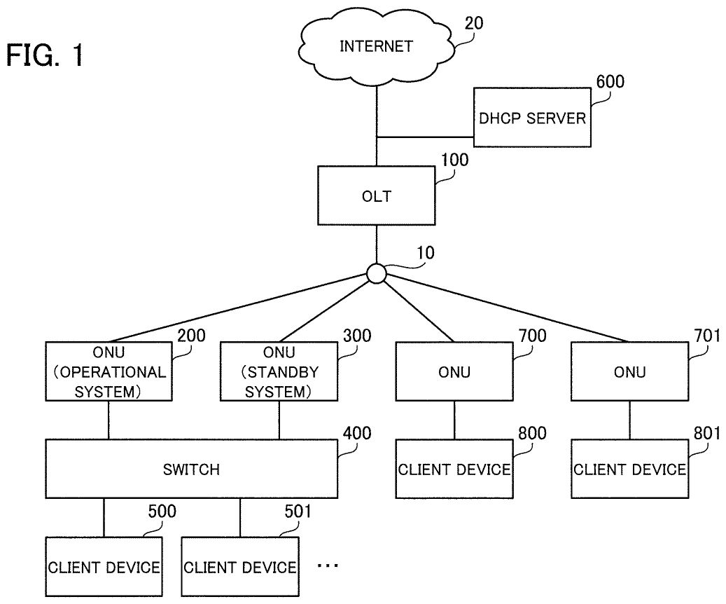

FIG. 1 is a diagram showing a communication system in a first embodiment. The communication system includes an OLT 100, an ONU 200, an ONU 300 and a client device 500. Further, the communication system may include a switch 400, a client device 500, a DHCP server 600, ONUS 700 and 701, and client devices 800 and 801.

A system including the OLT 100, the ONU 200, the ONU 300, the ONU 700 and the ONU 701 is referred to also as a PON system. The OLT 100 connects to the ONU 200, the ONU 300 and the ONUS 700 and 701 via a splitter 10.

In the PON system, control based on time division multiplexing of upstream signals is executed. Incidentally, the upstream signal is an optical signal transmitted by an ONU to the OLT 100. Thanks to the control based on the time division multiplexing, collision of optical signals can be prevented.

The OLT 100 is referred to also as a master station device. Further, the OLT 100 is referred to also as an optical communication device. The OLT 100 executes a control method. The OLT 100 connects to the Internet 20. The Internet 20 is referred to also as a network.

Each of the OLT 100, the ONU 200, the ONU 300, the ONU 700 and the ONU 701 measures the number of frames transmitted and received. By using the number of frames, a system administrator can analyze the occurrence status of an error frame, the presence/absence of a network attack, identification of an occupying user, and so forth.

The client devices 500, 501, 800 and 801 are referred to also as DHCP client devices. Each of the client devices 500, 501, 800 and 801 connects to the Internet 20 by using an IP address assigned thereto. For example, the client device 800 connects to the Internet 20 via the ONU 700. The client device 801 connects to the Internet 20 via the ONU 701.

Here, each ONU is referred to also as a slave station device. Further, the ONU 200 is assumed to be an ONU as an operational system. The ONU 200 is referred to also as a first slave station device. The ONU 300 is assumed to be an ONU as a standby system. The ONU 300 is referred to also as a second slave station device. In the first embodiment, the number of standby-system ONUS is assumed to be one. However, the number of standby-system ONUS can also be two or more.

The client devices 500 and 501 connect to the ONUS 200 and 300. Specifically, the client devices 500 and 501 connect to the ONUS 200 and 300 via the switch 400.

When the ONU 200 is an operational-system ONU, the client devices 500 and 501 connect to the Internet 20 via the ONU 200 and the OLT 100. For example, the client device 500 connects to the Internet 20 via the ONU 200 and the OLT 100 by using the IP address assigned to the client device 500. Incidentally, the IP address is referred to also as a first address.

When a failure occurs to the ONU 200, the ONU 300 switches to the operational-system ONU. Then, the client devices 500 and 501 connect to the Internet 20 via the ONU 300 and the OLT 100.

The switch 400 relays the communication between the operational-system ONU and the client devices 500 and 501. In FIG. 1, the number of client devices connected to the switch 400 is two. However, the number of client devices connected to the switch 400 can also be three or more.

The DHCP server 600 manages the IP addresses used for the connection to the Internet 20. The DHCP server 600 executes the assigning of IP addresses and releasing of IP addresses based on the DHCP.

Next, the assigning of the IP address will be described below.

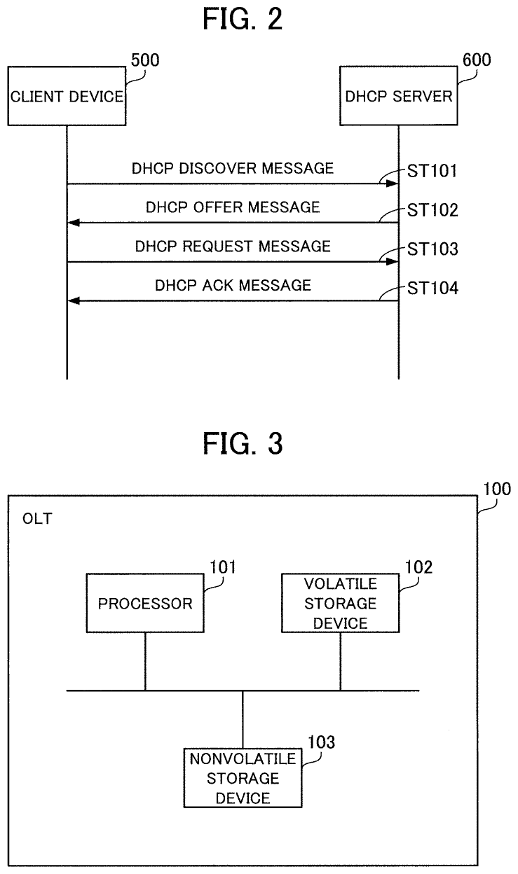

FIG. 2 is a sequence diagram showing an IP address assigning process in the first embodiment. FIG. 2 illustrates a case where the DHCP server 600 assigns an IP address to the client device 500. In FIG. 2, illustration of the OLT 100, the ONU 200 and the switch 400 is left out.

(Step ST101) The client device 500 transmits a DHCP discover message to the DHCP server 600. The DHCP discover message is a message requesting the assignment of the IP address.

(Step ST102) The DHCP server 600 transmits a DHCP offer message to the client device 500. The DHCP offer message is a message including an IP address that the client device 500 can use.

(Step ST103) When the IP address included in the DHCP offer message has no problem, the client device 500 transmits a DHCP request message to the DHCP server 600. The DHCP request message is a message officially requesting the DHCP server 600 to assign the IP address.

(Step ST104) The DHCP server 600 transmits a DHCP ack message to the client device 500. The DHCP ack message is a message for making the client device 500 set the IP address.

The client device 500 makes the setting of the IP address according to information indicated by the DHCP ack message. Accordingly, the client device 500 can connect to the Internet 20 by using the IP address.

Next, the main hardware configuration of the OLT 100 will be described below.

FIG. 3 is a diagram showing the configuration of hardware included in the OLT in the first embodiment. The OLT 100 includes a processor 101, a volatile storage device 102 and a nonvolatile storage device 103.

The processor 101 controls the whole of the OLT 100. For example, the processor 101 is a Central Processing Unit (CPU), a Field Programmable Gate Array (FPGA) or the like. The processor 101 can also be a multiprocessor. The OLT 100 may also be implemented by a processing circuitry or implemented by software, firmware or a combination of software and firmware. Incidentally, the processing circuitry may be either a single circuit or a combined circuit.

The volatile storage device 102 is main storage of the OLT 100. The volatile storage device 102 is a Random Access Memory (RAM), for example. The nonvolatile storage device 103 is auxiliary storage of the OLT 100. The nonvolatile storage device 103 is a flash memory, for example.

Each of the ONUs 200, 300, 700 and 701, the client devices 500, 501, 800 and 801 and the DHCP server 600 includes a processor, a volatile storage device and a nonvolatile storage device similarly to the OLT 100.

Next, functional blocks included in the OLT 100 and the ONUs 200 and 300 will be described below.

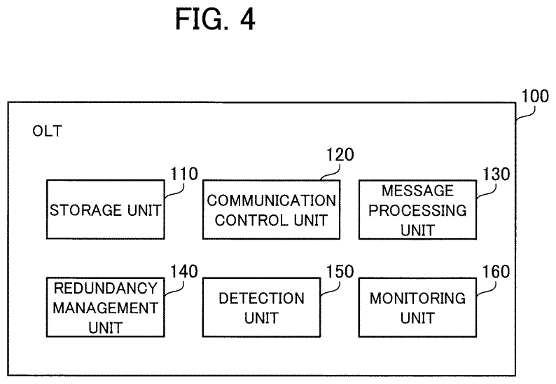

FIG. 4 is a functional block diagram showing the configuration of the OLT in the first embodiment. The OLT 100 includes a storage unit 110, a communication control unit 120, a message processing unit 130, a redundancy management unit 140, a detection unit 150 and a monitoring unit 160.

The storage unit 110 is implemented as a storage area secured in the volatile storage device 102 or the nonvolatile storage device 103.

Part or all of the communication control unit 120, the message processing unit 130, the redundancy management unit 140, the detection unit 150 and the monitoring unit 160 may be implemented by the processor 101. Part or all of the communication control unit 120, the message processing unit 130, the redundancy management unit 140, the detection unit 150 and the monitoring unit 160 may be implemented as modules of a program executed by the processor 101. For example, the program executed by the processor 101 is referred to also as a control program. The control program has been recorded in a record medium, for example.

The storage unit 110 stores a management table. The management table will be described here.

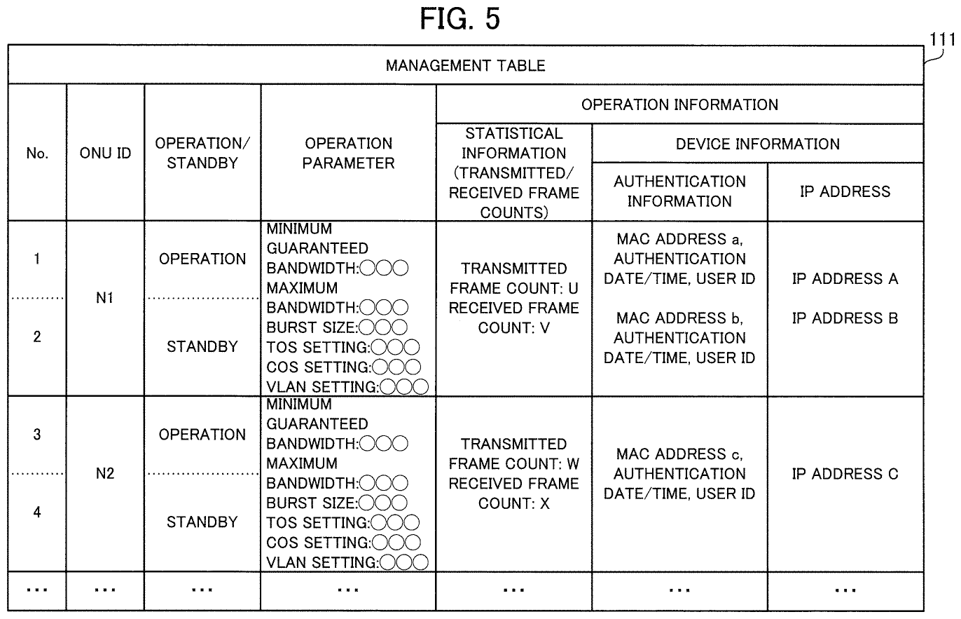

FIG. 5 is a diagram showing a concrete example of the management table in the first embodiment. The management table 111 is referred to also as management information. The management table 111 includes items of No., ONU IDENTIFIER (ID), OPERATION/STANDBY, OPERATION PARAMETER and OPERATION INFORMATION.

The item of No. indicates an identifier of each ONU. For example, No. 1 represents the ONU 200. No. 2 represents the ONU 300. Incidentally, illustration of ONUS corresponding to Nos. 3 and 4 is left out in FIG. 1.

The item of ONU ID indicates an identifier representing a combination of an operational-system ONU and a standby-system ONU. For example, an identifier representing a combination of the ONU 200 and the ONU 300 is N1.

As above, in the management table 111, the ONU 200 and the ONU 300 are managed by using one ONU ID.

The item of OPERATION/STANDBY indicates whether each ONU is in the state of an operational system or a standby system. For example, the management table 111 indicates that the ONU 200 is an operational system. Further, for example, the management table 111 indicates that the ONU 300 is a standby system.

The item of OPERATION PARAMETER indicates parameters previously set to each ONU.

The item of OPERATION INFORMATION includes items of STATISTICAL INFORMATION and DEVICE INFORMATION. The item of STATISTICAL INFORMATION indicates the number of frames transmitted and received by each ONU. Here, for example, the redundancy management unit 140 acquires the number of frames transmitted and received by the ONU 200 from the ONU 200 and registers the frame counts in the management table 111.

The item of DEVICE INFORMATION indicates information regarding a client device connected to each ONU. Specifically, the item of DEVICE INFORMATION includes items of AUTHENTICATION INFORMATION and IP ADDRESS.

The item of AUTHENTICATION INFORMATION indicates the Media Access Control (MAC) address of the client device connected to each ONU, the date and time of authentication of the client device, and a user ID of the user using the client device.

The item of IP ADDRESS indicates the IP address assigned to the client device connected to each ONU.

For example, the MAC address a is assumed to be the MAC address of the client device 500. The IP address A is assumed to be the IP address assigned to the client device 500. According to the relationship between the MAC address and the IP address, the device information indicates that the IP address A has been assigned to the client device 500.

As above, the management table 111 indicates, for example, that the IP address A has been assigned to the client device 500 connecting to the ONU 200 and the ONU 300. Further, for example, the management table 111 may also be represented as indicating a correspondence relationship between the identifier representing the combination of the ONU 200 and the ONU 300 and the information indicating that the IP address A has been assigned to the client device 500.

The communication control unit 120 has an Optical/Electrical (O/E) conversion function. Further, the communication control unit 120 executes transmission and reception of optical signals and electric signals.

The message processing unit 130 executes snooping. For example, the message processing unit 130 acquires the DHCP request message transmitted from the client device 500. The message processing unit 130 acquires the MAC address of the client device 500, information regarding the operational-system ONU to which the client device 500 is connected, and so forth from the DHCP request message. The message processing unit 130 stores the acquired information in the storage unit 110.

The redundancy management unit 140 manages the operational-system ONU 200 and the standby-system ONU 300. Further, the redundancy management unit 140 updates the management table 111 depending on a parameter that is set to the operational-system ONU and the state of the operational-system ONU.

The detection unit 150 detects occurrence of a failure to the operational-system ONU 200. Here, when the occurrence of a failure to the ONU 200 is detected, the communication control unit 120 connects to the ONU 300. The communication control unit 120 controls the communication performed by the client device so that the client device connects to the Internet 20 via the ONU 300 and the OLT 100. Accordingly, the client device can connect to the Internet 20.

For example, the monitoring unit 160 monitors the unauthorized use of the IP address assigned to the client device 500 based on the management table 111 both when the client device 500 connects to the Internet 20 via the ONU 200 and the OLT 100 and when the client device 500 connects to the Internet 20 via the ONU 300 and the OLT 100. For example, it is assumed here that the client device 800 transmits a frame to the Internet 20. The frame includes the MAC address of the client device 800 and the IP address assigned to the client device 500. The monitoring unit 160 acquires the frame via the communication control unit 120. The monitoring unit 160 refers to the management table 111 and compares the combination of the MAC address of the client device 500 and the IP address assigned to the client device 500 with the combination of the MAC address of the client device 800 and the IP address assigned to the client device 500. By the comparison, the monitoring unit 160 detects the unauthorized use of the IP address assigned to the client device 500. Incidentally, the unauthorized use is referred to also as spoofing.

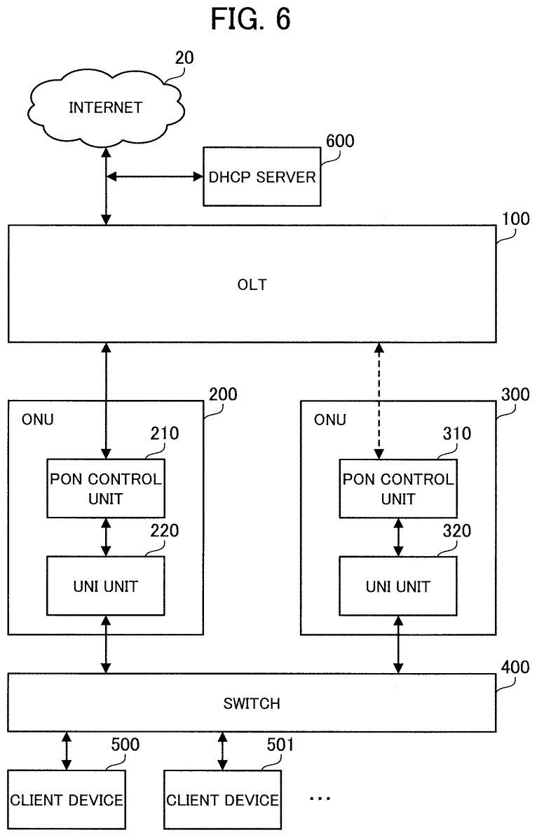

FIG. 6 is a functional block diagram showing the configuration of ONUS in the first embodiment. The ONU 200 includes a PON control unit 210 and a User Network Interface (UNI) unit 220.

Part or all of the PON control unit 210 and the UNI unit 220 may be implemented by a processor included in the ONU 200. Part or all of the PON control unit 210 and the UNI unit 220 may be implemented as modules of a program executed by the processor included in the ONU 200.

The ONU 300 includes a PON control unit 310 and a UNI unit 320. Part or all of the PON control unit 310 and the UNI unit 320 may be implemented by a processor included in the ONU 300. Part or all of the PON control unit 310 and the UNI unit 320 may be implemented as modules of a program executed by the processor included in the ONU 300.

Here, the function of the PON control unit 210 and the function of the PON control unit 310 are the same as each other. Further, the function of the UNI unit 220 and the function of the UNI unit 320 are the same as each other. Therefore, the description with reference to FIG. 6 will be given of the PON control unit 210 and the UNI unit 220. Then, the description is omitted for the PON control unit 310 and the UNI unit 320.

The PON control unit 210 has the 0/E conversion function. Further, the PON control unit 210 executes transmission and reception of optical signals and electric signals.

The UNI unit 220 communicates with the client devices 500 and 501 via the switch 400.

Next, a process executed in the communication system will be described below.

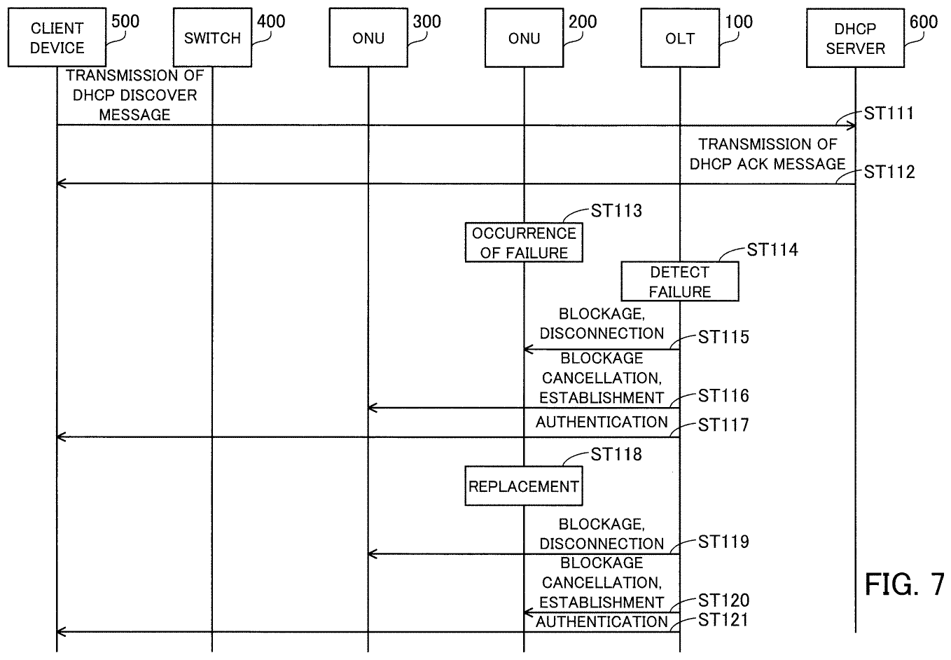

FIG. 7 is a sequence diagram showing an example of a process executed in the communication system in the first embodiment. Incidentally, the client device 501, the ONUS 700 and 701 and the client devices 800 and 801 are left out in FIG. 7.

Here, the ONU 300 has been set in a state of being incapable of transmitting upstream signals in order to hold down the power consumption while the ONU 300 stays on standby as the standby system. The state of being incapable of transmitting upstream signals is referred to as an optical shutdown state. Incidentally, the ONU 300 in the optical shutdown state is capable of receiving downstream signals. The downstream signal is an optical signal transmitted by the OLT 100 to an ONU. Further, in the ONU 300, the UNI unit 320 has been blocked off so as not to receive a frame from the client device 500.

(Step ST111) The client device 500 transmits the DHCP discover message to the DHCP server 600.

(Step ST112) The DHCP server 600 transmits the DHCP ack message to the client device 500.

Accordingly, the client device 500 can connect to the Internet 20 by using the IP address assigned by the DHCP server 600.

Incidentally, illustration of the transmission and reception of the DHCP offer message and the DHCP request message is left out between the step ST111 and the step ST112.

(Step ST113) A failure occurs to the ONU 200. For example, the failure is an abnormality occurring in the ONU 200 or a malfunction of the ONU 200.

(Step ST114) The detection unit 150 of the OLT 100 detects the occurrence of a failure to the ONU 200. For example, the detection unit 150 of the OLT 100 detects the occurrence of a failure to the ONU 200 when the power of an upstream signal transmitted by the ONU 200 is lower than a threshold value.

(Step ST115) The communication control unit 120 of the OLT 100 commands the ONU 200 to shift to the optical shutdown state. Further, the communication control unit 120 of the OLT 100 commands the ONU 200 to block off the UNI unit 220. The communication control unit 120 of the OLT 100 disconnects the logical link between the OLT 100 and the ONU 200. This disables the communication between the OLT 100 and the ONU 200. Further, since the logical link has been disconnected, the communication control unit 120 of the OLT 100 cancels the authentication of the ONU 200.

(Step ST116) The communication control unit 120 of the OLT 100 commands the ONU 300 to cancel its optical shutdown state and to cancel the state of blocking off the UNI unit 320.

The communication control unit 120 of the OLT 100 establishes the logical link between the OLT 100 and the ONU 300. Since the logical link has been established, the communication control unit 120 of the OLT 100 authenticates the ONU 300. Accordingly, the ONU 300 switches to the operational system.

Incidentally, information corresponding to the ONU 200 registered in the management table 111 will be used as information corresponding to the ONU 300. For example, the operation information registered when the ONU 200 was the operational system will be handled as operation information regarding the ONU 300. In other words, the operation information regarding the ONU 200 is handed over as the operation information regarding the ONU 300.

It is also possible for the OLT 100 to acquire the MAC address from the client device 500 again.

(Step ST117) The communication control unit 120 of the OLT 100 controls the communication performed by the client device 500 so that the client device 500 connects to the Internet 20 via the ONU 300 and the OLT 100. Specifically, the communication control unit 120 of the OLT 100 establishes the logical link between the OLT 100 and the ONU 300. After the logical link with the ONU 300 is established, the communication control unit 120 of the OLT 100 authenticates the client device 500.

Accordingly, the client device 500 can connect to the Internet 20.

(Step ST118) The ONU 200 is replaced with a new ONU. The new ONU is referred to as the ONU 200.

(Step ST119) The communication control unit 120 of the OLT 100 commands the ONU 300 to shift to the optical shutdown state. Further, the communication control unit 120 of the OLT 100 commands the ONU 300 to block off the UNI unit 320. The communication control unit 120 of the OLT 100 disconnects the logical link between the OLT 100 and the ONU 300. This disables the communication between the OLT 100 and the ONU 300. Further, since the logical link has been disconnected, the communication control unit 120 of the OLT 100 cancels the authentication of the ONU 300.

(Step ST120) The communication control unit 120 of the OLT 100 commands the ONU 200 to cancel its optical shutdown state and to cancel the state of blocking off the UNI unit 220.

The communication control unit 120 of the OLT 100 establishes the logical link between the OLT 100 and the ONU 200. Since the logical link has been established, the communication control unit 120 of the OLT 100 authenticates the ONU 200. Accordingly, the ONU 200 switches to the operational system.

(Step ST121) The communication control unit 120 of the OLT 100 authenticates the client device 500.

Incidentally, in the conventional technology, when an ONU as a standby system is switched to the operational system, the OLT deletes the information regarding the client device connected to the operational-system ONU. Then, the OLT generates information regarding the client device connected to the standby-system ONU. In this conventional method, the client device cannot connect to the Internet until the information is generated. Thus, there is a problem in that the client device cannot connect to the Internet for a long time.

According to the first embodiment, the OLT 100 uses the information corresponding to the ONU 200 registered in the management table 111 as information corresponding to the ONU 300. Thus, when the ONU 300 as the standby system is switched to the operational system, the OLT 100 does not delete information regarding the client devices 500 and 501 connected to the ONU 200 that has been registered in the management table 111. Namely, when the ONU 300 as the standby system is switched to the operational system, the OLT 100 does not delete the device information in the management table 111. Further, the OLT 100 does not register information regarding the client devices 500 and 501 newly connected to the ONU 300 in the management table 111. Therefore, the OLT 100 is capable of letting the client devices 500 and 501 connect to the Internet 20 in a short time.

### Second Embodiment

Next, a second embodiment will be described below. The following description will be given mainly of features different from those in the first embodiment, in which description will be omitted for features in common with the first embodiment. FIGS. 1 to 7 will be referred to in the description of the second embodiment.

In the first embodiment, a case where the ONU includes the UNI unit was described. In the second embodiment, a case where the ONU is of the Small Foam-factor Pluggable (SFP) type will be described.

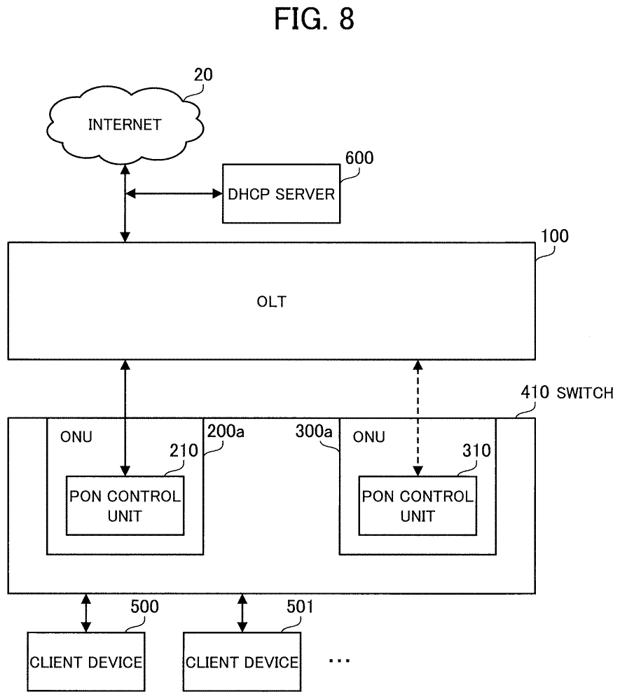

FIG. 8 is a functional block diagram showing the configuration of ONUS in the second embodiment. First, the communication system includes the OLT 100, a switch 410 and the client device 500. The communication system may include the client device 501, the DHCP server 600, the ONUS 700 and 701 and the client devices 800 and 801.

The switch 410 includes an ONU 200a of the SFP type and an ONU 300a of the SFP type. The ONU 200a is implemented as a module of an optical transceiver. The optical transceiver is referred to also as a first optical transceiver. The ONU 300a is implemented as a module of an optical transceiver. The optical transceiver is referred to also as a second optical transceiver. Specifically, the ONU 200a and the ONU 300a are inserted in a cage of the switch 410 and used. Incidentally, the ONU 200a is the operational system. The ONU 300a is the standby system.

Each component in FIG. 8 that is the same as a component shown in FIG. 6 is assigned the same reference character as in FIG. 6. The ONU 200a differs from the ONU 200 in including no UNI unit. The ONU 300a differs from the ONU 300 in including no UNI unit.

The ONU 200a and the ONU 300a cannot be blocked off since they include no UNI unit. Therefore, a mirroring function is enabled by the switch 410. For example, when the ONU 200a is the operational system and the ONU 300a is the standby system, a port of the ONU 300a is designated as the destination of the mirroring of a port of the ONU 200a. Accordingly, the switch 410 duplicates frames received by the ONU 200a from the client device for the ONU 300a. For example, frames transmitted by the client device 500 are received by the ONU 200a. Further, the frames are duplicated by the switch 410 and the duplicated frames are received by the ONU 300a. Here, when the ONU 300a is the standby system, the ONU 300a is in the optical shutdown state. Thus, the ONU 300a does not transmit the duplicated frames to the OLT 100. Accordingly, the OLT 100 receives only the frames transmitted by the ONU 200a.

Incidentally, no logical link has been established between the OLT 100 and the ONU 300a. Therefore, the ONU 300a does not receive downstream signals.

According to the second embodiment, even in cases where the ONU 200a and the ONU 300a are of the SFP type, the OLT 100 is capable of letting the client devices 500 and 501 connect to the Internet 20 in a short time.

### Third Embodiment

Next, a third embodiment will be described below. The following description will be given mainly of features different from those in the first embodiment, in which description will be omitted for features in common with the first embodiment. FIGS. 1 to 7 will be referred to in the description of the third embodiment.

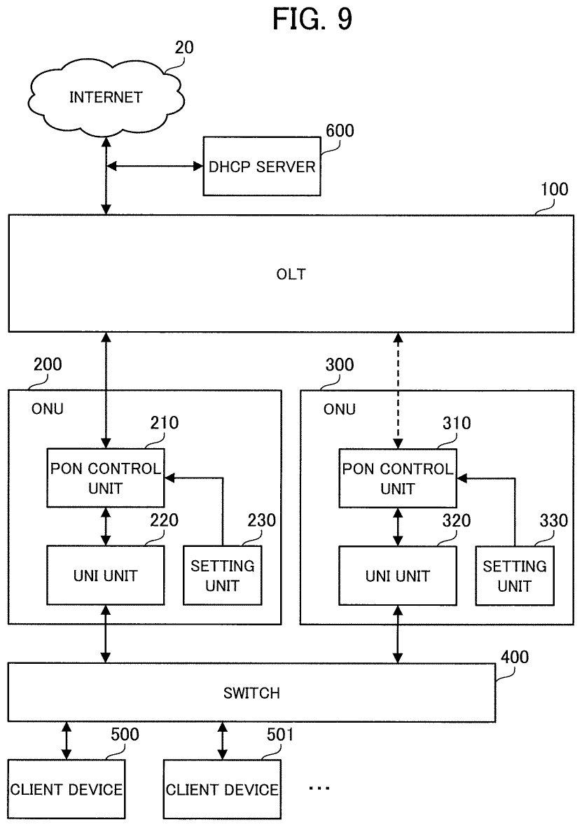

FIG. 9 is a functional block diagram showing the configuration of ONUS in the third embodiment. Each component in FIG. 9 that is the same as a component shown in FIG. 6 is assigned the same reference character as in FIG. 6.

The ONU 200 further includes a setting unit 230. For example, the setting unit 230 may be implemented by a rotary switch. The setting unit 230 sets an ONU ID to the ONU 200.

The ONU 300 further includes a setting unit 330. For example, the setting unit 330 may be implemented by a rotary switch. The setting unit 330 sets an ONU ID to the ONU 300. Incidentally, the ONU ID set to the ONU 200 and the ONU ID set to the ONU 300 are the same as each other.

After the logical link has been established between the OLT 100 and the ONU 200, the communication control unit 120 acquires the ONU ID and the MAC address of the ONU 200 from the PON control unit 210. Further, after the logical link has been established between the OLT 100 and the ONU 300, the communication control unit 120 acquires the ONU ID and the MAC address of the ONU 300 from the PON control unit 310.

The communication control unit 120 registers the ONU ID and the MAC address of the ONU 200 in an ONU authentication table. Further, the communication control unit 120 registers the ONU ID and the MAC address of the ONU 300 in the ONU authentication table. Here, a concrete example of the ONU authentication table will be shown below.

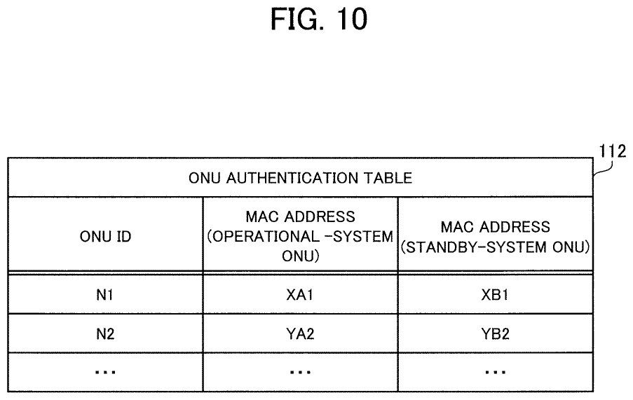

FIG. 10 is a diagram showing an example of the ONU authentication table in the third embodiment. The ONU authentication table 112 is stored in the storage unit 110. The ONU authentication table 112 includes items of ONU ID, MAC ADDRESS OF OPERATIONAL-SYSTEM ONU, and MAC ADDRESS OF STANDBY-SYSTEM ONU.

Here, the MAC address of the ONU 200 is assumed to be XA1. The MAC address of the ONU 300 is assumed to be YA1.

For example, the fact that the ONU ID indicating the combination of the ONU 200 and the ONU 300 is N1 is registered in the ONU authentication table 112. As in this example, the ONU 200 and the ONU 300 are managed by using the same ONU ID.

Next, a description will be given of a process regarding the ONU authentication and the UNI blockage executed by the OLT 100 when the ONU redundancy is not employed.

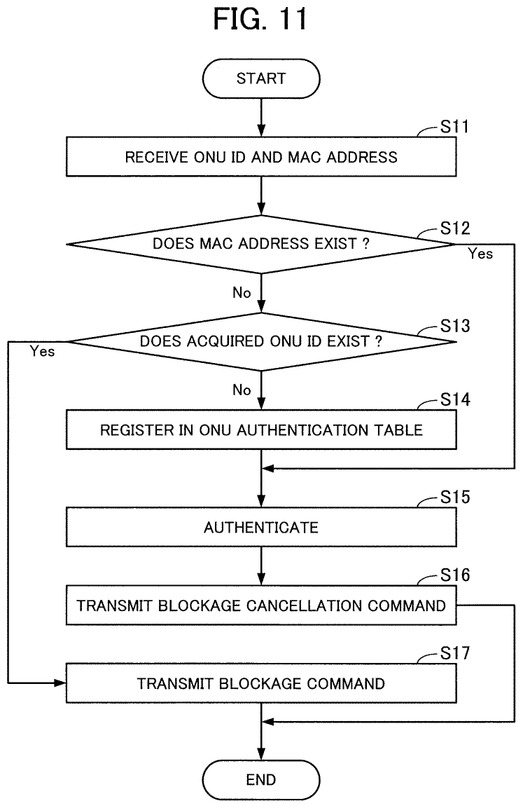

FIG. 11 is a flowchart showing the process regarding the ONU authentication and the UNI blockage when the ONU redundant configuration is not employed in the third embodiment. Namely, this flowchart is a flowchart showing the process regarding the ONU authentication and the UNI blockage when the ONU redundancy is not employed and an additional ONU is connected to the OLT. For example, the process of FIG. 11 is started when the logical link has been established between the OLT 100 and the ONU 700.

(Step S11) The communication control unit 120 receives the ONU ID and the MAC address from the ONU 700.

(Step S12) The communication control unit 120 judges whether or not the acquired MAC address exists in the ONU authentication table 112.

When the MAC address exists in the ONU authentication table 112, the communication control unit 120 advances the process to step S15. When the MAC address does not exist in the ONU authentication table 112, the communication control unit 120 advances the process to step S13.

(Step S13) The communication control unit 120 judges whether or not the acquired ONU ID exists in the ONU authentication table 112.

When the ONU ID exists in the ONU authentication table 112, the communication control unit 120 advances the process to step S17. When the ONU ID does not exist in the ONU authentication table 112, the communication control unit 120 advances the process to step S14.

(Step S14) The communication control unit 120 registers the acquired ONU ID and MAC address in the ONU authentication table 112.

(Step S15) The communication control unit 120 authenticates the ONU 700.

(Step S16) The communication control unit 120 transmits a blockage cancellation command to the ONU 700. Then, the communication control unit 120 ends the process.

(Step S17) The communication control unit 120 transmits a blockage command to the ONU 700. Accordingly, the ONU 700 blocks off its UNI unit. Further, the communication control unit 120 commands the ONU 700 to shift to the optical shutdown state.

Here, the system administrator can modify the registered contents of the ONU authentication table 112 by using a terminal device. Incidentally, illustration of the terminal device is left out in FIG. 9.

Next, a description will be given of a method of determining whether a newly added ONU should operate as the operational system or operate as the standby system when the new ONU is added to the communication system in a state in which the OLT 100 has authenticated one or more ONUS. Here, the new ONU is assumed to be the ONU 300.

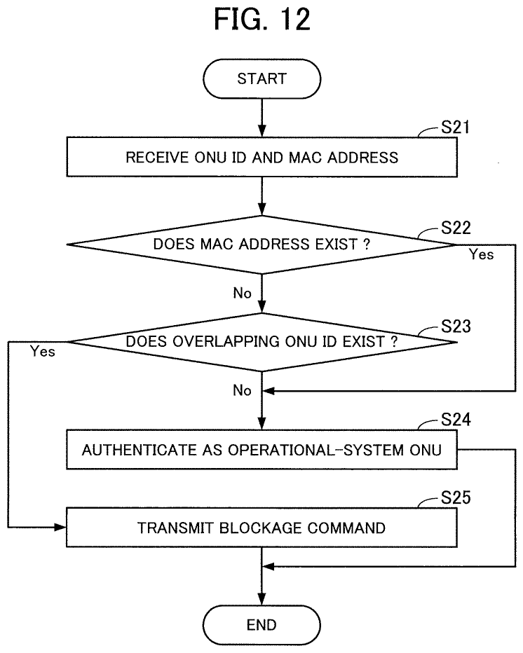

FIG. 12 is a flowchart showing a process regarding the ONU authentication and the UNI blockage when a new ONU has been added when the ONU redundant configuration is employed in the third embodiment. For example, the process of FIG. 12 is started when the logical link has been established between the OLT 100 and the ONU 300.

(Step S21) The communication control unit 120 receives the ONU ID and the MAC address from the ONU 300.

(Step S22) The communication control unit 120 judges whether or not the acquired MAC address exists in the ONU authentication table 112.

When the MAC address exists in the ONU authentication table 112, the communication control unit 120 advances the process to step S24. When the MAC address does not exist in the ONU authentication table 112, the communication control unit 120 advances the process to step S23.

(Step S23) The communication control unit 120 judges whether or not an ONU ID overlapping with the acquired ONU ID exists in the ONU authentication table 112.

When an overlapping ONU ID exists in the ONU authentication table 112, the communication control unit 120 advances the process to step S25. When no overlapping ONU ID exists in the ONU authentication table 112, the communication control unit 120 registers the ONU ID and the MAC address in the ONU authentication table 112. Then, the communication control unit 120 advances the process to the step S24.

(Step S24) The communication control unit 120 authenticates the ONU 300 as the operational system.

(Step S25) The communication control unit 120 transmits the blockage command to the ONU 300. Accordingly, the ONU 701 blocks off its UNI unit. Further, the communication control unit 120 commands the ONU 300 to shift to the optical shutdown state.

According to the third embodiment, the OLT 100 can manage the ONU 200 and the ONU 300 by using the same ONU ID.

Features in the embodiments described above can be appropriately combined with each other.

### DESCRIPTION OF REFERENCE CHARACTERS

10: splitter, 20: Internet, 100: OLT, 101: processor, 102: volatile storage device, 103: nonvolatile storage device, 110: storage unit, 111: management table, 112: ONU authentication table, 120: communication control unit, 130: message processing unit, 140: redundancy management unit, 150: detection unit, 160: monitoring unit, 200, 200a, 300, 300a, 700, 701: ONU, 210: PON control unit, 220: UNI unit, 230: setting unit, 310: PON control unit, 320: UNI unit, 330: setting unit, 400, 410: switch, 500, 501, 800, 801: client device, 600: DHCP server.

1. An optical communication device as a master station device in a communication system that includes:
a first slave station device as a slave station device as an operational system;
a second slave station device as a slave station device as a standby system;
the master station device to connect to a network; and
a client device to connect to the first slave station device and the second slave station device and connect to the network via the first slave station device and the master station device by using a first address,
wherein the optical communication device comprises:
a memory to store management information indicating that the first address has been assigned to the client device that connects to the first slave station device and the second slave station device;
a detecting circuitry to detect occurrence of a failure to the first slave station device;
a communication controlling circuitry to connect to the second slave station device when the occurrence of the failure to the first slave station device is detected and control communication performed by the client device so that the client device connects to the network via the second slave station device and the master station device; and
a monitoring circuitry to monitor unauthorized use of the first address based on the management information both when the client device connects to the network via the first slave station device and the master station device and when the client device connects to the network via the second slave station device and the master station device.

2. The optical communication device according to claim 1, wherein the management information indicates a correspondence relationship between an identifier representing a combination of the first slave station device and the second slave station device and information indicating that the first address has been assigned to the client device.

3. The optical communication device according to claim 1, wherein
the first slave station device is implemented as a module of a first optical transceiver, and
the second slave station device is implemented as a module of a second optical transceiver.

4. A control method executed by an optical communication device as a master station device in a communication system that includes:
a first slave station device as a slave station device as an operational system;
a second slave station device as a slave station device as a standby system;
the master station device to connect to a network; and
a client device to connect to the first slave station device and the second slave station device and connect to the network via the first slave station device and the master station device by using a first address,
wherein the control method comprises:
detecting occurrence of a failure to the first slave station device,
connecting to the second slave station device,
controlling communication performed by the client device so that the client device connects to the network via the second slave station device and the master station device, and
monitoring unauthorized use of the first address based on management information indicating that the first address has been assigned to the client device that connects to the first slave station device and the second slave station device both when the client device connects to the network via the first slave station device and the master station device and when the client device connects to the network via the second slave station device and the master station device.

5. An optical communication device as a master station device in a communication system that includes:
a first slave station device as a slave station device as an operational system;
a second slave station device as a slave station device as a standby system;
the master station device to connect to a network; and
a client device to connect to the first slave station device and the second slave station device and connect to the network via the first slave station device and the master station device by using a first address,
wherein the optical communication device comprises
a processor to execute a program; and
a memory to store the program which, when executed by the processor, performs processes of,
detecting occurrence of a failure to the first slave station device;
connecting to the second slave station device;
controlling communication performed by the client device so that the client device connects to the network via the second slave station device and the master station device; and
monitoring unauthorized use of the first address based on management information indicating that the first address has been assigned to the client device that connects to the first slave station device and the second slave station device both when the client device connects to the network via the first slave station device and the master station device and when the client device connects to the network via the second slave station device and the master station device.
